(19) United States
(12) Patent Application Publication
(10) Pub. No.: US 2020/0189330 A1
(43) Pub. Date: Jun. 18, 2020

(54) LIGHTWEIGHT BEAD FOR A TIRE

(71) Applicant: The Goodyear Tire & Rubber Company, Akron, OH (US)

(72) Inventors: Paul Joseph Endres, Brecksville, OH (US); Ceyhan Celik, Stow, OH (US); James Gregory Gillick, Akron, OH (US); Leonard James Reiter, Ravenna, OH (US); James Christopher Kish, New Franklin, OH (US)

(21) Appl. No.: 16/220,061

(22) Filed: Dec. 14, 2018

(51) Int. Cl. B60C 15/04; D02G 3/02; D02G 3/36; D02G 3/48; D07B 1/06

(52) U.S. Cl. CPC B60C 15/04; D02G 3/02; D02G 3/36; D02G 3/48; D07B 1/0606; D10B 2331/30; B60C 2015/046; D10B 2101/06; D10B 2101/12; D10B 2101/08; B60C 2015/042

(57) ABSTRACT

A bead for a tire in accordance with the present invention includes a core with at least one yarn of a multifilament textile fiber embedded in an organic matrix having a density between 0.9 g/m³ and 2.0 g/m³ and an outer sheath layer including at least one metal wire wound around, and in contact with, the core. The core has a diameter between 5.0 mm and 30.0 mm.

### FIELD OF INVENTION

The present invention relates to beads for tires, and, in particular, to lightweight hybrid beads for pneumatic tires, such as aircraft tires.

### BACKGROUND OF THE PRESENT INVENTION

Conventionally, a tire comprises two circumferential beads that are intended to allow the tire to be fitted on the rim. Each bead may include an annular reinforcing bead core. A conventional tire for a ground vehicle may include a bead including a core and an outer layer of one or more steel wires wound around the core. The core may be a steel monofilament. The steel monofilament may bend around on itself with its two ends welded together in order to form an approximately circular ring or hoop.

In addition to a relatively high weight, such a bead may also exhibit plastic deformation. Thus, after steps of transport and/or storage, during which the tire is squashed under its own weight or under the weight of other tires, the bead may exhibit irreversible plastic deformation. Such deformation may degrade the mechanical properties of the bead, resulting in inadequate clamping of the bead to the rim. Consequently, airtightness and other performance of the tire may be degraded.

Another conventional bead for a tire may include a core of at least one yarn of a multifilament textile fiber embedded in an organic matrix and an outer layer of at least one metal wire wound around, and in contact with, the core. By definition, a textile fiber is non-metallic. A multifilament textile fiber may include elementary textile filaments that are arranged side by side and oriented in a substantially unidirectional manner. The elementary filaments are thus more or less parallel to one another, apart from the occasional overlap.

The textile fiber may reinforce the organic matrix. Such a fiber may be chosen, for example, from the group consisting of polyvinyl alcohol fibers, aromatic polyamide (or “aramid”) fibers, polyester fibers, aromatic polyester fibers, polyethylene fibers, cellulose fibers, rayon fibers, viscose fibers, polyphenylene benzobisoxazole (“PBO”) fibers, polyethylene naphthenate (“PEN”) fibers, glass fibers, carbon fibers, silica fibers, ceramic fibers, and mixtures of such fibers.

The organic matrix may be any matrix including, by weight, more than 50 percent organic material. The organic matrix may contain minerals and/or metals that come from its manufacturing process, but also deliberately added mineral and/or metal additives. Thus, the organic matrix may be a thermosetting polymeric matrix, for example, based on an unsaturated polyester, polyepoxide, a phenolic derivative, and/or aminoplast, or else a thermostable polymeric matrix based on cyanate, poly(bismaleimide), polyimide, polyamidoimide, or a thermoplastic polymeric matrix based on polypropylene, polyamide, saturated polyester, polyoxymethylene, polysulphone and polyethersulphone, polyether ketone and polyether ether ketone, polyphenylene sulphide, and/or polyetherimide, or a thermoplastic or crosslinked elastomer based on polyurethane, silicone, and/or rubber or even an organic matrix that results from a mixture of these matrices.

The organic matrix may be thermoset and crosslinked. For example, a resin that is crosslinkable by ionizing radiation, such as ultraviolet-visible radiation and/or a beam of accelerated electrons or X rays. A composition including a resin that is crosslinkable by a peroxide may also be chosen. The crosslinkable resin may be made of a polyester resin (i.e. based on unsaturated polyester) or a vinyl ester resin.

The core may include a single yarn and form a monolithic torus. The term “monolithic” may mean that the torus has no discontinuities of material or joints on a macroscopic scale. Elementary filaments may be distributed homogeneously throughout the volume of the torus. Alternatively, the core may form a winding of the yarn in a number of coils and include a plurality of separate yarns. The yarns may be assembled by cabling, such as wound together in a helix without a twist about their own axis. The yarns may also be assembled by twisting, such as wound together in a helix and undergoing both a collective twist and an individual twist about their own axis. Further, the core may include a plurality of monolithic torusses juxtaposed parallel to one another.

### Definitions

The following definitions are controlling for the present invention.

“Axial” and “Axially” means the lines or directions that are parallel to the axis of rotation of the tire.

“Axially Inward” means in an axial direction toward the equatorial plane.

“Axially Outward” means in an axial direction away from the equatorial plane.

“Bead” or “Bead Core” generally means that part of the tire comprising an annular tensile member of radially inner beads that are associated with holding the tire to the rim.

“Belt Structures” or “Reinforcement Belts” or “Belt Package” means at least two annular layers or plies of parallel cords, woven or unwoven, underlying the tread, unanchored to the bead, and having both left and right cord angles in the range from 18 degrees to 30 degrees relative to the equatorial plane of the tire.

“Carcass” means the tire structure apart from the belt structure, tread, undertread over the plies, but including the beads.

“Circumferential” most often means circular lines or directions extending along the perimeter of the surface of the annular tread perpendicular to the axial direction; it can also refer to the direction of the sets of adjacent circular curves whose radii define the axial curvature of the tread, as viewed in cross section.

“Directional Tread Pattern” means a tread pattern designed for specific direction of rotation.

“Equatorial Plane” means the plane perpendicular to the tire's axis of rotation and passing through the center of its tread; or the plane containing the circumferential centerline of the tread.

“Footprint” means the contact patch or area of contact of the tire tread with a flat surface under normal load pressure and speed conditions.

“Groove” means an elongated void area in a tread that may extend circumferentially or laterally in the tread in a straight, curved or zigzag manner. It is understood that all groove widths are measured perpendicular to the centerline of the groove.

“Lateral” means a direction going from one sidewall of the tire towards the other sidewall of the tire.

“Net to gross” means the ratio of the net ground contacting tread surface to the gross area of the tread including the ground contacting tread surface and void spaces comprising grooves, notches and sipes.

“Notch” means a void area of limited length that may be used to modify the variation of net to gross void area at the edges of blocks.

“Ply” means a cord-reinforced layer of rubber coated radially deployed or otherwise parallel cords.

“Radial” and “radially” mean directions radially toward or away from the axis of rotation of the tire.

“Radial Ply Tire” means a belted or circumferentially-restricted pneumatic tire in which at least one ply has cords which extend from bead to bead are laid at cord angles between 65 degrees and 90 degrees with respect to the equatorial plane of the tire.

“Saturated” means not enough room between adjacent primary windings of a cable such that additional windings cannot be wound between the primary windings.

“Shoulder” means the upper portion of sidewall just below the tread edge.

“Sidewall” means that portion of a tire between the tread and the bead.

“Sipe” means a groove having a width in the range of 0.2 percent to 0.8 percent of the tread width. Sipes are typically formed by steel blades having a 0.4 to 1.6 mm, inserted into a cast or machined mold.

“Tangential” and “Tangentially” refer to segments of circular curves that intersect at a point through which can be drawn a single line that is mutually tangential to both circular segments.

“Tread” means the ground contacting portion of a tire.

“Tread width” (TW) means the greatest axial distance across the tread, when measured (using a footprint of a tire,) laterally from shoulder to shoulder edge, when mounted on the design rim and subjected to a specified load and when inflated to a specified inflation pressure for said load.

“Void Space” means areas of the tread surface comprising grooves, notches and sipes.

### SUMMARY OF THE INVENTION

A bead for a tire in accordance with the present invention includes a core with at least one yarn of a multifilament textile fiber embedded in an organic matrix having a density between 0.9 g/m³ and 2.0 g/m³ and an outer sheath layer including at least one metal wire wound around, and in contact with, the core. The core has a diameter between 5.0 mm and 30.0 mm, or 5.0 mm and 20.0 mm.

According to another aspect of the bead, the core includes a single yarn of the multifilament textile fiber.

According to still another aspect of the bead, the core includes a plurality of separate yarns of the multifilament textile fiber.

According to yet another aspect of the bead, each yarn of the multifilament textile fiber has a yield strength between 2000 MPa and 2500 MPa.

According to still another aspect of the bead, each yarn of the multifilament textile fiber has a Young's modulus less than or equal to 300 GPa.

According to yet another aspect of the bead, a ratio of a mass of the core to a mass of the bead is less than 0.5.

According to still another aspect of the bead, the ratio of a force at break of the core to the force at break of the entire bead is greater than or equal to 0.25.

According to yet another aspect of the bead, a contribution of the core to a force at break of the entire bead is between 5 percent and 30 percent, or 15 percent and 25 percent, or equal to 20 percent.

According to still another aspect of the bead, the contribution of the core to the force at break of the bead is between 5 percent and 60 percent, or 20 percent and 40 percent, or 25 percent and 35 percent.

According to yet another aspect of the bead, a ratio of a mass of the core to a mass of the bead is between 40 percent and 60 percent, or 45 percent and 55 percent.

According to still another aspect of the bead, the ratio of the mass of the core to the mass of the bead is greater than or equal to 5 percent, or greater than or equal to 10 percent.

According to yet another aspect of the bead, a ratio of the diameter of the core to a diameter of a bead is greater than or equal to 0.4.

According to still another aspect of the bead, a force at break of the bead core is greater than or equal to 200 MPa, or between 15 kN and 20 kN, or 17 kN and 18 kN.

According to yet another aspect of the bead, a diameter of each yarn of the multifilament textile fiber is between 0.5 mm and 6.0 mm.

According to still another aspect of the bead, a diameter of each elementary filament of each multifilament textile fiber is between 2.0 μm and 30.0 μm.

According to yet another aspect of the bead, each multifilament textile fiber is continuous.

According to still another aspect of the bead, each multifilament textile fiber includes more than 10 elementary filaments.

According to yet another aspect of the bead, each multifilament textile fiber is chosen from a group of fibers consisting of: glass fibers, polyphenylene benzobisoxazole (“PBO”), carbon fibers, silica fibers, ceramic fibers, and mixtures thereof.

According to another aspect of the bead, the organic matrix is a thermoset type of matrix.

A tire according to the present invention includes at least one bead. Each bead includes a core that has at least one yarn of a multifilament textile fiber embedded in an organic matrix having a density between 0.9 g/m³ and 2.0 g/m³ and an outer layer that includes a metal wire wound around, and in contact with, the core. The core has a diameter between 5.0 mm and 30.0 mm, or 5.0 mm and 20.0 mm.

### BRIEF DESCRIPTION OF THE DRAWINGS

The present invention will be better understood on reading the following description, which is given solely by way of nonlimiting example, with reference to the drawings, in which:

FIG. 1 is a schematic cross-sectional view of a tire for use with the present invention;

FIG. 2 is a schematic cross-sectional view of a bead according to one example of the present invention; and

FIG. 3 is a schematic cross-sectional view of a bead according to one example of the present invention.

### DESCRIPTION OF EXAMPLES OF THE PRESENT INVENTION

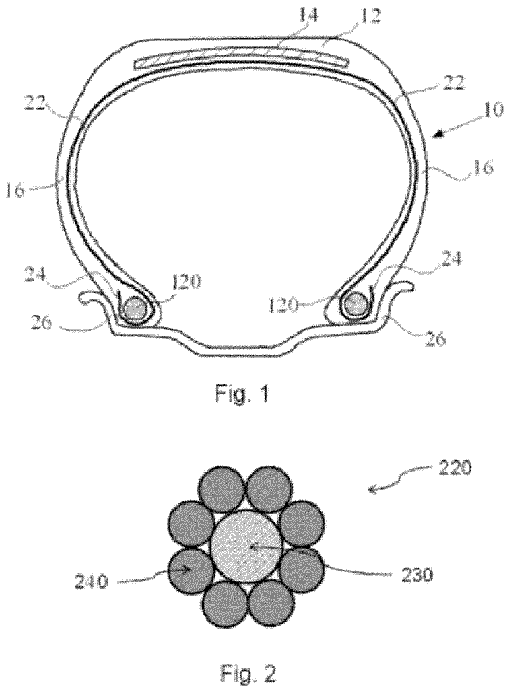

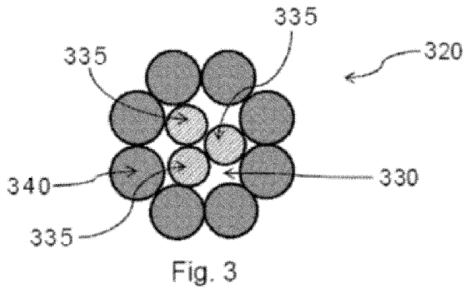

FIG. 1 shows a tire 10, pneumatic or non-pneumatic, for use with the present invention. As an example, the tire 10 may be a tire for an aircraft. The tire 10 may have a crown 12 reinforced by a crown reinforcement, or belt structure 14; two sidewalls 16; and two annular beads 120. The crown 12 may be surmounted by a tread, not shown in this schematic figure. A carcass reinforcement 22 may be wound around the two beads 120 and include a turn-up 24 disposed towards the outside of each bead 120 fitted onto a wheel rim 26. The carcass reinforcement 22 may include at least one ply reinforced with radial cords. Each bead 120 may have a toroidal overall shape with an approximately circular cross section (FIGS. 2-3). Alternatively, the bead 120 may have a square, rectangular, hexagonal, and/or other polygon cross section or an elliptical or oblong cross section (not shown).

As shown in FIG. 2, another bead 220 may include a core 230 and an outer sheath layer 240. The bead core 230 may have a circular cross-section and a single core. The bead core 30 may include a single yarn forming a monolithic torus. The core 230 may have an approximately circular cross section and an exemplary diameter between 7.0 mm and 10.00 mm, or about 8.90 mm. The core 230 may include a multifilament textile fiber embedded in an organic matrix. The multifilament textile fiber of the core 230 may be a glass fiber and the organic core matrix may be a thermoset resin. The multifilament textile fiber of the core 230 may be continuous or discontinuous. The glass fiber of the core 230 may include more than 1000 elementary glass filaments arranged side by side and parallel to one another, apart from an occasional overlap. The diameter of each elementary filament of the textile fiber of the core 230 may be between 2.0 μm and 30.0 μm. The thermoset resin may be of the vinyl ester type, such as an epoxy vinyl ester. The core 230 may be manufactured by impregnation of the fiber, such as described in U.S. Pat. No. 3,730,678, incorporated herein by reference in its entirety, or by injection of the organic matrix into a mold in which the fiber has previously been placed, such as described in document U.S. Pat. No. 7,032,637, incorporated herein by reference in its entirety.

The sheath layer 240 of the bead 220 may include one or more metal wires (e.g., 1, 2, 3, 4, 5, 6, 7, 8, 9, 10 or more, etc.) wound in a helix around the core 230. The wire(s) of the sheath layer 240 may be wound around, and in contact with, the core 230 and have a circular cross-section with a diameter between 1.0 mm and 2.0 mm, or 1.30 mm. The wire(s) of the sheath layer 240 may be made a steel with a carbon content less than 0.9 percent, by weight of steel. The wire(s) of the sheath layer 240 may be wound over one or more turns, such as between 6 and 10 turns, or 8 turns. The sheath layer 240 may “saturated.” The two ends of the wire of the sheath layer 240 may be connected by means of a sleeve (not shown).

Still another bead 320 for use with the present invention may include a core 330 with three coils 335, each of a single yarn. Each of the three coils 335 may include a single yarn forming three separate monolithic torusses wound (e.g. twisting, cabling. etc.) about each other. Each of the three coils 335 of the core 330 may have a circular cross section with an exemplary diameter between 7.0 mm and 10.0 mm, or 8.9 mm. Each of the coils 335 may include a multifilament textile fiber embedded in an organic matrix. As described above, the multifilament textile fiber of the core 330 may be a glass fiber and the organic core matrix may be a thermoset resin. The multifilament textile fiber of the core 330 may be continuous or discontinuous. The glass fiber of the core 330 may include more than 1000 elementary glass filaments arranged side by side and parallel to one another, apart from an occasional overlap. The diameter of each elementary filament of the textile fiber of the core 330 may be between 2.0 μm and 30.0 μm. The thermoset resin may be of the vinyl ester type, such as an epoxy vinyl ester. The core 330 may be manufactured by impregnation of the fiber, such as described in U.S. Pat. No. 3,730,678, incorporated herein by reference in its entirety, or by injection of the organic matrix into a mold in which the fiber has previously been placed, as described in U.S. Pat. No. 7,032,637, incorporated herein by reference in its entirety.

Traverse winding of each coil 335 over a number of turns may be carried out such that the core 330 has a substantially triangular cross section (FIG. 3) with a diameter of each coil between 0.5 mm and 3.0 mm, or between 1.0 mm and 2.0 mm, or 1.5 mm. A diameter of the torus defined by the bead 320 may be between 4.0 mm and 8.0 mm, or 5.8 mm. The diameter of the torus defined by the core 330 may be between 2.0 mm and 5.0 mm, or 3.28 mm. The wire of the sheath 340 may have a diameter between 1.0 mm and 3.0 mm, or 1.5 mm.

The sheath layer 340 may include one or more metal wires (e.g., 2, 3, 4, 5, 6, 7, 8, 9, 10 or more, etc.) wound in a helix around the core 330. A single wire of the sheath layer 340 may be wound around, and in contact with, the core 330 and have a circular cross-section with a diameter between 1.0 mm and 2.0 mm, or 1.30 mm. The single wire of the sheath layer 40 may be a steel with a carbon content greater than or equal to 0.9 percent, by weight of the steel. The wire of the sheath layer 340 may be wound over one or more turns, such as between 6 and 10 turns, or 8 turns. The sheath layer 340 may “saturated.” The two ends of the wire of the sheath layer 340 may be connected by means of a sleeve (not shown).

Alternatively, as shown in FIG. 3, another bead 320 for use with the present invention may include a core 330 with three coils 335, each of a single yarn. Each of the three coils 335 may include a single yarn forming three separate monolithic torusses extending parallel to each other. Each of the three coils 335 of the core 330 may have a circular cross section with an exemplary diameter between 7.0 mm and 10.0 mm, or 8.9 mm. Each of the coils 335 may include a multifilament textile fiber embedded in an organic matrix. As described above, the multifilament textile fiber may be a glass fiber and the organic core matrix may be a thermoset resin. The multifilament textile fiber may be continuous or discontinuous. The glass fiber may include more than 1000 elementary glass filaments arranged side by side and parallel to one another, apart from an occasional overlap. The diameter of each elementary filament of the textile fiber may be between 2.0 μm and 30.0 μm. The thermoset resin may be of the vinyl ester type, such as an epoxy vinyl ester. The core 30 may be manufactured by impregnation of the fiber, as described in document U.S. Pat. No. 3,730,678, incorporated herein by reference in its entirety, or by injection of the organic matrix into a mold in which the fiber has previously been placed, as described in document U.S. Pat. No. 7,032,637, incorporated herein by reference in its entirety.

Traverse winding of each coil 335 over a number of turns may be carried out such that the core 30 has a substantially polygonal, in this case triangular cross section (FIG. 3) with a diameter of each coil between 0.5 mm and 3.0 mm, or between 1.0 mm and 2.0 mm, or 1.5 mm. A diameter of the torus defined by the bead 320 may be between 4.0 mm and 8.0 mm, or 5.8 mm. The diameter of the torus defined by the core 330 may be between 2.0 mm and 5.0 mm, or 3.28 mm. The wire of the sheath 340 may have a diameter between 1.0 mm and 3.0 mm, or 1.5 mm.

The beads 120, 220, 320 according to the present invention may be fitted on any type of tire. For example, the bead may be intended for a tire for industrial vehicles chosen from vans, heavy vehicles (e.g., metro vehicles, buses, road transport vehicles (lorries, tractors, trailers), off-road vehicles, aircraft, agricultural, and/or construction plant machinery, and other transport or handling vehicles. Further, the characteristics of the beads 120, 220, 320 may be mixed and/or combined with one another in any suitable way compatible with one another.

In accordance with the present invention, the cores 30, 230, 330 may have a diameter between 5.0 mm and 30.0 mm, or 6.0 mm and 8.0 mm, or 7.0 mm. This larger diameter of the cores 30, 230, 330 thereby allows the further reduction of the weight of the beads 20, 220, 320 of the tire 10. As described above, the wire of the sheaths 40, 240, 340 may have a diameter between 1.0 mm and 3.0 mm, or 1.5 mm. Aluminum generally may have a density of 2.71 g/m³ whereas the polymeric resin system of the cores 30, 230, 330 may be generally between 0.5 g/m³ and 2.0 g/m³, or 0.9 g/m³ and 2.0 g/m³, or 0.9 g/m³ and 1.8 g/m³, or 1.74 g/m³. Thus, a 35 percent reduction in weight or the same sized cores may be achieved. Further, the break strength of aluminum may be 1,360 ft*lb whereas the polymeric resin may be 4300 ft*lb. The molding process may also provide a perfectly continuous structure with no aluminum welding, which is the current practice for aluminum core production.

While the present invention has been described in connection with what is considered the most practical examples, it is to be understood that the present invention is not to be limited to the disclosed arrangements, but is intended to encompass various arrangements which are included within the spirit and scope of the broadest possible interpretation of the appended claims so as to include all possible modifications and equivalent arrangements. Numerous modifications and variations of the present invention are possible in light of the above teachings. It is therefore to be understood that, within the scope of the appended claims, the present invention may be practiced otherwise than as specifically and exemplarily described herein.

What is claimed:

1. A bead for a tire comprising:
a core including at least one yarn of a multifilament textile fiber embedded in an organic matrix having a density between 0.9 g/m³ and 2.00 g/m³, the core having a diameter between 5.0 mm and 30.0 mm; and
an outer sheath layer including at least one metal wire wound around and in contact with the core.

2. The bead as set forth in claim 1 wherein the core includes a single yarn of the multifilament textile fiber.

3. The bead as set forth in claim 1 wherein the core includes a plurality of separate yarns of the multifilament textile fiber.

4. The bead as set forth in claim 1 wherein each yarn of the multifilament textile fiber has a yield strength greater than 2000 MPa.

5. The bead as set forth in claim 1 wherein each yarn of the multifilament textile fiber has a Young's modulus less than or equal to 300 GPa.

6. The bead as set forth in claim 1 wherein a ratio of a mass of the core to a mass of the bead is less than 0.6.

7. The bead as set forth in claim 6 wherein the ratio of the force at break of the bead core to the force at break of the bead is greater than or equal to 0.25.

8. The bead as set forth in claim 1 wherein a contribution of the core to a force at break of the entire bead is between 5 percent and 60 percent.

9. The bead as set forth in claim 8 wherein the contribution of the core to the force at break of the bead is between 5 percent and 30 percent.

10. The bead as set forth in claim 1 wherein a ratio of a mass of the core to a mass of the bead is between 40 percent and 60 percent.

11. The bead as set forth in claim 10 wherein the ratio of the mass of the core to the mass of the bead is greater than or equal to 0.05.

12. The bead as set forth in claim 1 wherein a ratio of the diameter of the core to a diameter of a bead is greater than or equal to 0.4.

13. The bead as set forth in claim 1 wherein the bead core has an ultimate break strength greater than or equal to 200 MPa.

14. The bead as set forth in claim 1 wherein a diameter of each yarn of the multifilament textile fiber is between 0.5 mm and 6.0 mm.

15. The bead as set forth in claim 1 wherein a diameter of each elementary filament of each multifilament textile fiber is between 2.0 μm and 30.0 μm.

16. The bead as set forth in claim 1 wherein each multifilament textile fiber is continuous.

17. The bead as set forth in claim 1 wherein each multifilament textile fiber includes more than 10 elementary filaments.

18. The bead as set forth in claim 1 wherein each multifilament textile fiber is chosen from a group of fibers consisting of: glass fibers, carbon fibers, polyphenylene benzobisoxazole (PBO), silica fibers, ceramic fibers, and mixtures thereof.

19. The bead as set forth in claim 1 wherein the organic matrix is a thermoset type of matrix.

20. A tire comprising at least one bead,
each bead including a core that includes at least one yarn of a multifilament textile fiber embedded in an organic matrix having a density between 0.9 g/m³ and 2.0 g/m³ and an outer layer that includes a metal wire wound around, and in contact with, the core, the core having a diameter between 5.0 mm and 30.0 mm.
